(19) United States
(12) Patent Application Publication
(10) Pub. No.: US 2010/0074723 A1
(43) Pub. Date: Mar. 25, 2010

(54) Cargo Container

(76) Inventor: Donnie M. Lancon, Dickenson, TX (US)

Correspondence Address: J. Scott McBride;The McBride Law Firm, PC, 4265 San Felipe, Suite 1100, Houston, TX, 77027, US

(21) Appl. No.: 12/545,071

(22) Filed: Aug. 21, 2009

Related U.S. Application Data
(60) Provisional application No. 61/090,613, filed on Aug. 21, 2008.

(51) Int. Cl. B65D 88/00; B65G 65/00

(52) U.S. Cl. 414/800; 220/1.5

(57) ABSTRACT

Embodiments described herein comprise a system and method for collapsing a cargo container. The system may include a top container portion and a bottom container portion. One container portion is configured to fit into the other container portion thereby allowing the container to move between an expanded and a collapsed position. The container moves from an expanded position capable of being loaded with freight for shipping to a collapsed position for shipping when empty or when less freight is needed to ship.

### CROSS-REFERENCE TO RELATED APPLICATION

This application claims the priority benefit of U.S. provisional patent application No. 61/090,613, titled “Cargo Container,” filed Aug. 21, 2008. This related application is hereby incorporated by reference in its entirety.

### BACKGROUND

Embodiments of the inventive subject matter generally relate to the field of portable storage containers, and more particularly, to cargo containers that can be reduced in size for storage and shipping when not in use.

Shipping containers vary by dimensions, tare weight, transportation method and door size. Once a container is manufactured its dimensions remain fixed and the chassis remains rigid. The containers are used to ship cargo by boat, plane, train and truck to locations around the world. The containers are often shipped back to their original port empty in order to refill the container. When the containers are not in use, they are stored at the owners' warehouse, lot or other facility until needed again.

### SUMMARY

Embodiments described herein may include a cargo container comprising a top container portion. The top container portion may include a roof, two top side walls, a top back, and a top door portion. The cargo container may further comprise a bottom container portion. The bottom container portion may comprise a bottom, two bottom side walls, a bottom back, and a bottom door portion. The cargo container may further comprise a container expansion system configured to move the cargo container from an expanded position to a collapsed position, wherein the top container portion is configured to move in a telescoping fashion relative to the bottom container portion between the expanded position and the collapsed position.

Embodiments described herein may include a cargo container, comprising. The cargo container may comprise a top container portion and a bottom container portion. The top container portion may be configured to move relative to the bottom container portion and wherein at least a portion of the bottom container portion is configured to fit within the top container portion. The cargo container may further comprise one or more locking systems configured to lock the top container portion in an expanded and collapsed position relative to the bottom container portion. The cargo container may further comprise a door.

Embodiments described here may include a method for shipping cargo. The method may comprise loading a cargo container with cargo and shipping the cargo container to a destination. The method may further include unloading the cargo container and unlocking a top portion of the cargo container from a bottom portion of the cargo container. The method may further include telescoping the bottom container portion into the top container portion thereby collapsing the cargo container and shipping the collapsed cargo container to a second destination.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a diagram illustrating a collapsible cargo container in an expanded position according to some embodiments.

FIG. 2 depicts a diagram illustrating a collapsible cargo container in a collapsed position according to some embodiments.

FIG. 3 depicts a diagram illustrating a perspective view of a collapsible cargo container in an expanded position according to some embodiments.

FIG. 4 depicts a cross sectional top view of a collapsible cargo container according to some embodiments.

FIG. 5A depicts a guide portion of the collapsible cargo container according to some embodiments.

FIG. 5B depicts a cross sectional view of a guide portion of the collapsible cargo container according to some embodiments.

FIG. 5C depicts a cross sectional view of a guide portion of the collapsible cargo container according to some embodiments.

FIG. 6 depicts a cross sectional top view of a guide portion of the collapsible cargo container according to some embodiments.

FIG. 7A depicts a perspective diagram illustrating an interior wall of the cargo container according to some embodiments of the invention.

FIG. 7B depicts a cross sectional view illustrating a limit stop in the walls of the cargo container according to some embodiments of the invention.

FIG. 7C depicts a cross sectional view illustrating a limit stop in the walls of the cargo container according to some embodiments of the invention.

FIG. 7D depicts a cross sectional perspective view illustrating a limit stop and a seal in the walls of the cargo container according to some embodiments of the invention.

FIG. 8 depicts a perspective view illustrating the cargo container and a lock system according to some embodiments of the invention.

FIG. 9A depicts a top view of a locking system according to some embodiments of the invention.

FIG. 9B depicts an perspective end view of a lock actuator according to some embodiments of the invention.

FIG. 9C depicts a top view of a portion of a locking system according to some embodiments of the invention.

FIG. 9D depicts a top view of a portion of a locking system according to some embodiments of the invention.

FIG. 9E depicts a side view of a portion of a locking system according to some embodiments of the invention.

FIG. 9F depicts a side view of a portion of a locking system according to some embodiments of the invention.

FIG. 10 depicts a front view of a container according to some embodiments of the invention.

### DESCRIPTION OF EMBODIMENT(S)

The description that follows includes exemplary apparatus, methods, techniques, and instruction sequences that embody techniques of the present inventive subject matter. However, it is understood that the described embodiments may be practiced without these specific details.

Embodiments described herein comprise an apparatus and method for collapsing a cargo container. The collapsing cargo container system allows a cargo container to collapse thus minimizing storage space needed for unfilled containers or partially filled containers. With the cargo container in a collapsed position the number of containers which may be placed in a storage space, on a boat, on a truck, or on a train is increased dramatically. In one embodiment, the cargo container utilizes a telescoping system to collapse the container. The telescoping system enables a top container portion to telescope relative to a bottom container portion. Thus, the cargo container may move between an expanded position and a collapsed position. In the expanded position the cargo container may be filled with freight for shipping. In the collapsed position the cargo container has a reduced outer circumference which allows more cargo containers to be stored in a location.

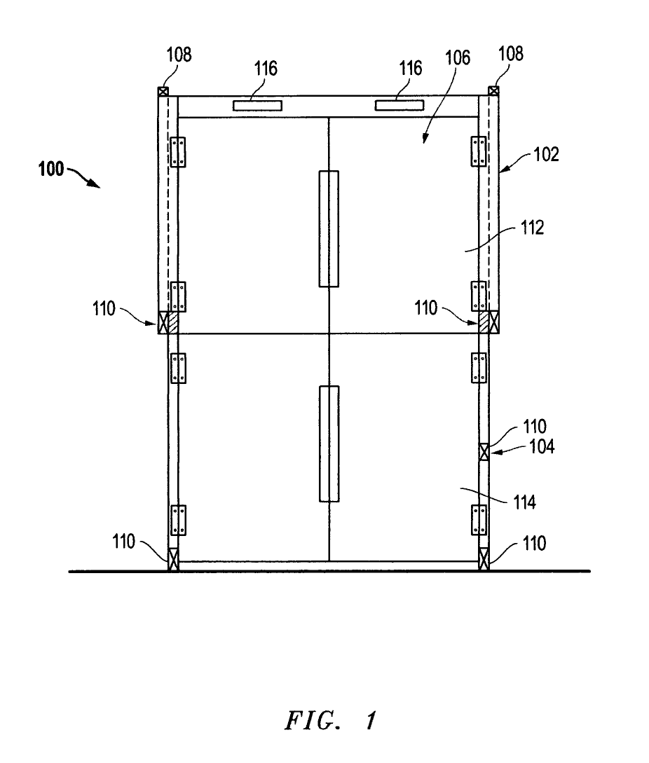

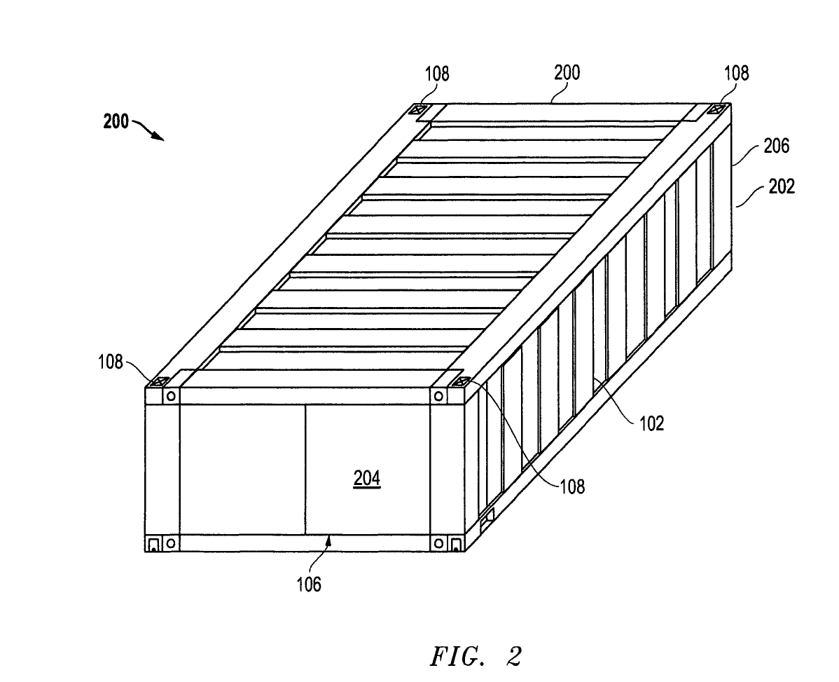

FIG. 1 depicts a cargo container 100 configured to move between an expanded position, as shown, and a collapsed position. In the expanded position, the cargo container 100 may be filled with cargo for transporting to various locations around the world. In the collapsed position, as shown in FIG. 2, the cargo container 100 may have an outer circumference, or volume, that is reduced from the size of the cargo container 100 in the expanded position. In the collapsed position, the cargo container 100 may be filled with less cargo than the cargo container 100 may contain in the expanded position, or stored empty. Due to the decreased size of the cargo container 100 in the collapsed position, more cargo containers 100 may be stored, and/or transported, than may be stored with standard sized containers, or the expanded cargo containers 100.

The cargo container 100 may include a top container portion 102 and a bottom container portion 104. The cargo container 100 may include a door 106 for allowing access to the interior of the cargo container 100. The cargo container 100 may further include one or more lift lugs 108, shown schematically, for lifting the cargo container 100 with a crane. The cargo container 100 may further include one or more container locks systems 110 configured to lock the cargo container 100 in the expanded and collapsed positions. As shown, the top container portion 102 has a slightly larger inner width and length dimension than the outer width and length dimension of the bottom container portion 104. The larger inner width and length allows the top container portion 102 to collapse, or telescope, over the bottom container portion 104. The top container portion 102 may collapse completely, or partially, over the bottom container portion 104. It should be appreciated that the bottom container portion 104 may be larger than the top container portion 102 in some embodiments to allow the top container portion 102 to collapse, or telescope, into the bottom container portion 104.

The top container portion 102 may include a roof 200, two top side walls 202, a top back (not shown), and a top door portion 204, as shown in FIG. 2. The roof 200 couples to the top of each of the top side walls 202 and the top back. The connection between the roof 200 and the side walls 202 and the top back may be any suitable connection including, but not limited to, a bolted connection, a welded connection, a riveted connection, and the like. Further, the connection may be one integral piece. The top door 204 may couple to the top side walls 202 and/or the roof 200 as will be discussed below. The exterior of the roof 200, the top side walls 202, the top back and the top door portion 204 may have any suitable surface. As shown, the exterior is corrugated in a similar manner as typical shipping containers; however, it should be appreciated that the exterior may have any suitable shape including, but not limited to, smooth, corrugated, textured and the like.

The bottom container portion 104 may include a bottom (not shown), two bottom side walls 300, a bottom back (not shown), and a bottom door portion 302, as shown in FIG. 3. The bottom, the bottom back and the bottom side walls 300 may couple together in a similar manner as the top container portion's are coupled together and described above. The bottom door 302 may couple to the bottom side walls 300 and/or the bottom as will be discussed below. The exterior of the bottom side walls 300 and bottom back may be similar to the top side walls 202 and top back. In addition, the exterior of the bottom side walls 300 and/or the bottom back may include one or more guide portions 304. The guide portions 304 are configured to guide the top container portion 102 as the top container portion 102 moves between the expanded position and the collapsed position.

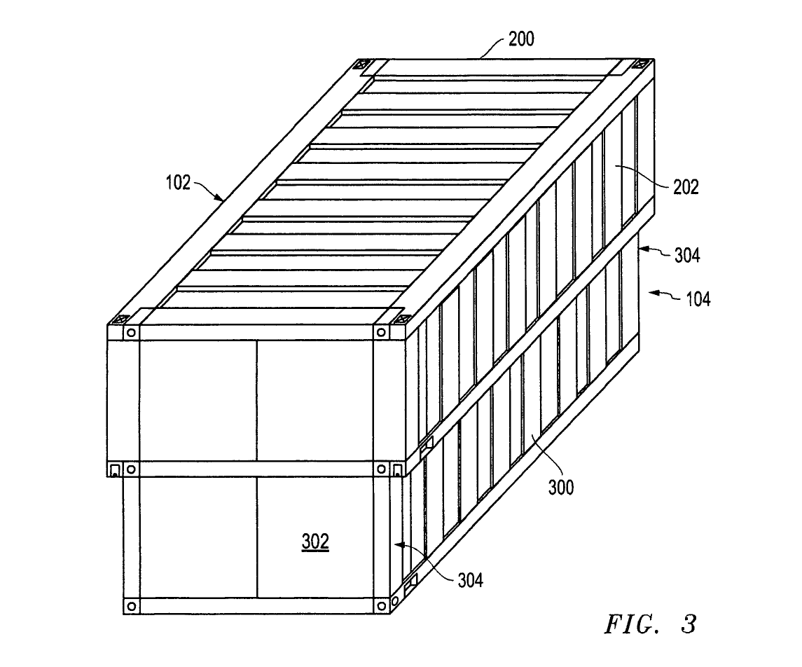

The guide portions 304 guide the movement of the top container portion 102 relative to the bottom container portion 104. The guide portions 304 may assist in reducing friction between the container portions 102 and 104 as the container 100 moves between the collapsed and expanded positions. Further, the guide portions may assist in reducing the twisting, and/or binding of the container 100 as the container 100 moves between the collapsed and expanded positions. In one embodiment, the guide portions 304 are posts at each of the four corners of the both the top container portion 102 and the bottom container portion 104, as shown in FIG. 4. FIG. 4 shows a cross sectional view of the container 100 cut through the guide portions 304 of both the top container portion 102 and the bottom container portion 104 when the container 100 is between the expanded and collapsed position. The posts as shown have a square, or rectangular, cross section. The top container portion 102 and the bottom container portion 104 are sized so that one surface of each of the posts are proximate one another. For example, the posts at each corner of the top container portion 102 have a top guide surface 400. The top guide surface 400 is configured guide the top container portion 102 by engaging a bottom guide surface 402. The top guide surface 400 may be configured to directly engage the bottom guide surfaces 402 as the container 100 moves between the collapsed and expanded position. Further, there may be one or more friction reducing members 404 located between the top guide surface 400 and the bottom guide surface 402 in order to reduce the friction between the guide surfaces 400 and 402 when the container 100 moves between the collapsed and expanded position.

In addition to the bottom posts engaging the top posts at the top and bottom guide surfaces 400 and 402, the bottom posts may have bottom guide surfaces which engage the top container back 406 and/or a portion of the top container front 408. The top container back 406 and the top container front 408 may have a guide surface 410 configured to engage the bottom post and/or the friction reducing member 404. The guide surface 410 may be configured to operate in a similar manner as the top guide surface 400 described above. The guide surface 410 may be a separate portion of the top back 406 and top front 408, or be integral with the top back 406 and top front 408. The guide surfaces 410 may prevent the bottom container portion 104, and/or the top container portion 102 from moving along an axis X relative to the container 100. The guide surfaces 400, 402 and 410 may keep the top container portion 102 in constant contact with the bottom container portion 104 as the containers move between the collapsed and expanded position. The contact between the surfaces may prevent the top container portion 102 from binding, or twisting, relative to the bottom container portion 104 as container expands and collapses.

The posts may be any suitable size and/or shape for providing the surface area required between the guide surfaces 400, 404 and/or 410. Further, there may be more than four posts on the top container portion 102 and/or the bottom container portion 104. Thus, there may be one or more intermediate sets of posts (not shown) between the corner posts of the container 100. These intermediate posts may act in a similar manner to any of the guide portions 304 described herein.

In yet another embodiment, a substantial portion of the top container portion 102 inner wall, and the bottom container portion 104 outer wall may be configured to be the guide surfaces discussed herein. In this example, the outer wall of the bottom contain portion 104 and the inner wall of the top container portion 102 would act in a similar manner to any of the guide portions described herein.

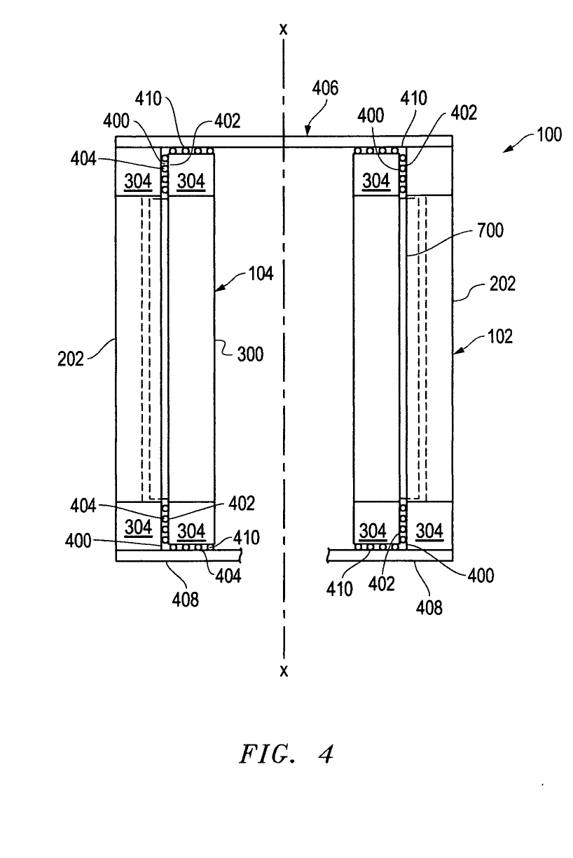

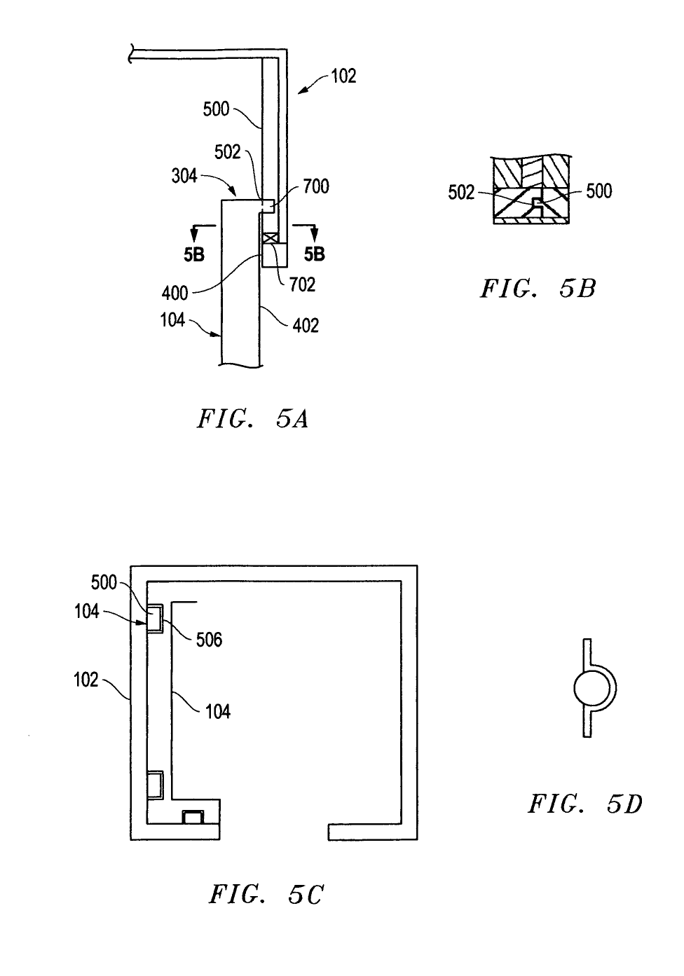

In an additional embodiment, one or more of the guide portions 304 may include a tongue 500 and groove 502 configured to assist in guiding the container 100 as it moves between the collapsed and expanded position, as shown in FIGS. 5A and 5B. The tongue 500 as shown is coupled to, or integral with the guide portion 304, or post, or the top container portion 102. The tongue 500 is configured to fit in and slide within the groove 502 of the guide portion 304 of the lower container portion 104. The surfaces between the tongue 500 and the groove 502 may include any combination of the friction reducing members 404 described herein. Although the tongue 500 is described as being located on the top container portion 102 and the groove 502 is described as being located on the bottom container portion 104 it should be appreciated that the tongue 500 may be located on the bottom container portion 104 and the groove may be located on the top container portion 102.

In an additional embodiment, the guide portions 304 may simply be a plurality of tongues 500 and grooves 502 located between the top container portion 102 and the bottom container portion 104 as shown in FIG. 5C. In this embodiment, the tongue 500 and groove 502 act as the guide portion 304 in a similar manner as described above but without the post. As shown, the tongue 500 is located on the inner wall of the top container portion 102 and the groove 502 is located on the outer wall of the bottom container portion 104. However, it should be appreciated that the tongue 500 may be located on the outer wall of the bottom container portion 104 and the groove 502 may be located on the inner wall of the top container portion 102. There may be any number of the tongue 500 and the groove 502 guide portions 304 located between the container portions 102 and 104. Although, the tongue 500 and groove 502 are shown as being square, it should be appreciated that any suitable matching component shapes may be used to assist in guiding the container portions 102 and 104 as they moved between the collapsed and expanded position including, but not limited to a circular shape, a semicircular shape, a T-Shape, flat surface, and the like.

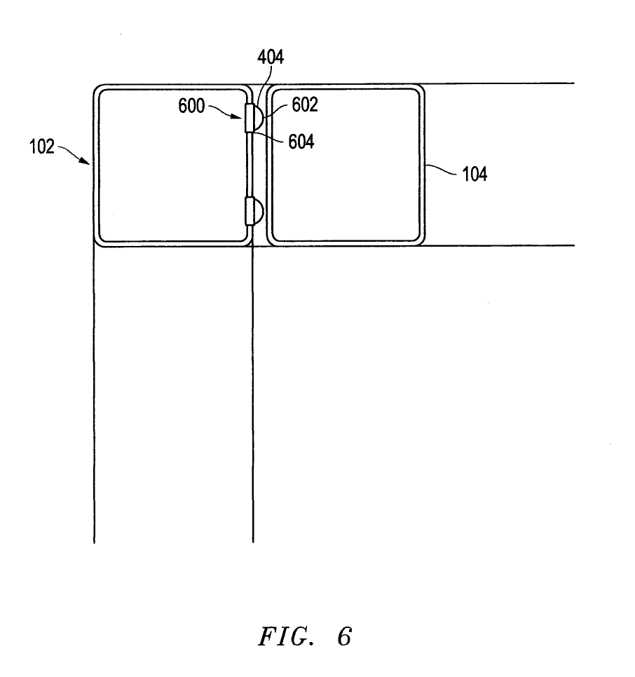

In one embodiment, the friction reducing members 404 may be a plurality of roller bearings 600 in one embodiment as shown in FIG. 6. The roller bearings 600 may include a rolling member 602, or ball, and a mount 604. The mount 604 may couple directly to the top guide surface 400, the bottom guide surface 402, and/or the guide surface 410. The mount 604 secures the roller bearing to the surface it is attached to. The mount 604 may be secured to the surface using any known fastening means including, but not limited to, a weld, a screw, a rivet, a bolt, and the like. Further, it should be appreciated that the mount 604 may be integral with the surface it is attached to. The mount 604 may hold the rolling member 602 in a manner that allows the rolling member 602 to roll in place if contacted. The surface opposite of the surface that the mount 604 is coupled to may be configured to engage the rolling member 602. As shown, the bottom guide surface 402 engages the rolling member 602. When the top container portion 102 is moved relative to the bottom container portion 104, the bottom guide surface 402 moves relative to the rolling member 602. The bottom guide surface 402 may cause the rolling member to roll in the mount 604 thereby allowing the container 100 to move between the expanded and the collapsed position with relatively little friction. It should be appreciated that mount 604 may be on any of the surfaces described herein, for example, the mount 604 may be coupled to the bottom guide surface 402 while the rolling member 602 engages the top guide surface 400.

Although the friction reducing members 404 are described as being roller bearings, it should be appreciated that any suitable device for reducing friction between the moving parts of the container 100 may be used including, but not limited to, one or more Teflon slide plates, one or more ball bearings, one or more wheel style bearings, one or more greased surfaces, and the like.

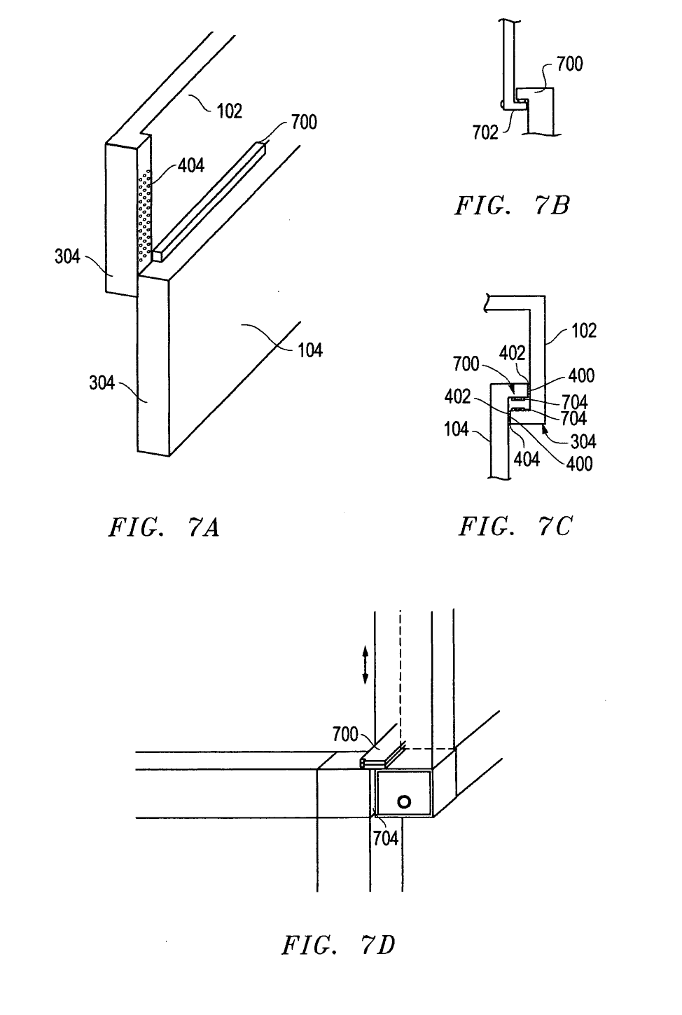

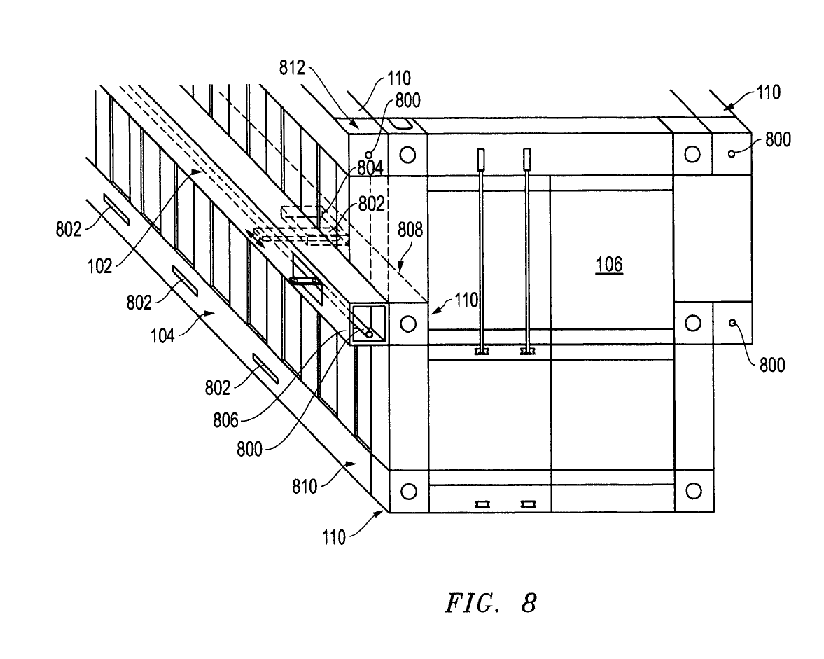

The container may include a limit stop 700 configured to stop the travel of the top container portion 102 relative to the bottom container portion 104 when the container 100 reaches the expanded position. FIG. 7A shows a perspective view of a portion of the interior of the container 100 showing the limit stop 700 attached to a portion of the bottom container portion 104. The limit stop 700 may be configured to engage a shoulder 702, as shown in FIG. 7B, of the top container portion 102. When the shoulder 702 engages the limit stop 700, the top container portion 102 may not further expand relative to the bottom container portion 702. Thus, the limit stop 700 and the shoulder 702 limit the expansion of the container 100.

As shown, the limit stop 700 is a rigid member that extends toward the interior wall of the top container portion 102 from a top portion of a wall of the bottom container portion 104. The shoulder 702 may be a rigid member that extends toward the exterior wall of the bottom container portion 104 from a bottom portion of the wall of the top container portion 102. The limit stop 700 and shoulder 702 may be located between the guide portions 304. The limit stop 700 and/or the shoulder 702 may be configured to extend the entire length of the walls between the guide portions 304. Further, it should be appreciated that the limit stops 700 and/or the shoulders 702 may be configured to extend only between a portion of the walls between the guide portions 304.

The limit stop 700 and/or the shoulder 702 may be a separate removable member coupled to the container portions 102 and 104, or may be integral with the container portions 102 and 104. A removable limit stop 700 and/or shoulder may be beneficial in that if the limit stop 700, or shoulder 702, are damaged they may simply be removed and replaced. The removable limit stop 700 and/or shoulder 702 may be coupled to the container portions 102 and 104 using any suitable connection member including, but not limited to, bolts, screws, welds, rivets, and the like. The limit stop 700 and the shoulder 702 may have any suitable shape configured to engage one another and thereby stop the travel between the top container portion 102 and the bottom container portion 104.

The limit stop 700 as shown in FIGS. 7A and 7B extends between the guide portions 304 of the container 100, however, it should be appreciated that the limit stops 700 and the shoulders 702, may be integral with the guide portions 304, as shown in FIGS. 5A and 7C. FIG. 7C depicts a cross sectional view of the container 100 through an additional embodiment of the guide portions 304. In this embodiment, the top of the guide portion 304 on the bottom container portion 104 includes a limit stop 700. The guide portion 304 of the top container portion 102 may include the shoulder 702. Further in this embodiment, a portion of the limit stop 700 may include the bottom guide surface 402 as described above in addition to the bottom guide surface 402 located on the exterior of the wall of the bottom container portion 104. The shoulder 702 may include the top guide surface 400 as described above in addition to the top guide surface 400 located on the interior wall of the top container portion 102.

When travelling toward the collapsed position the limit stop 700 may engage the roof of the container 100 thereby limiting the amount the container 100 may collapse. Further any suitable item may serve as a limit to the travel in the collapsed position including, but not limited a second limit stop (not shown) engaging a second shoulder.

In an embodiment, there may be one or more seals 704 between portions of the top container portion 102 and the bottom container portion 104, as shown in FIGS. 7C, 7D and 5A. The seal 704 may be configured to prevent moisture and/or fluids from flowing past the seal 704. The seal 704 may be located between one or more portions of the top container portion 102 and the bottom container portion 104 which engage one another. Thus, the one or more seals 704 may prevent or inhibit the flow of moisture and or fluids between portions of the top container portion 102 and the bottom container portion 104. As shown in FIGS. 7C, 7D and 5A the seal 704 is located between the limit stop 700 and the shoulder 702. Thus, when the limit stop 700 engages the shoulder 702, the seal 704 may substantially prevent the flow of fluids between the limit stop 700 and the shoulder 704. The seal 704 may have only one seal member located on one of the engaging surfaces, for example the shoulder 704, as shown in FIG. 5A. With only one seal member, the seal 704 may be configured to engage a container surface, for example the limit stop 700, thereby sealing the surfaces. Further, the seal may have two seal members configured to engage one another, as shown in FIG. 7C, thereby sealing the surfaces when engaging one another.

The seal members of the seal 704 may be configured of any suitable material, and/or configuration capable of substantially preventing the flow of fluids and/or moisture past the seal 704 when the seal is engaged against another surface. In one embodiment, the seal member is one or more elastomeric member configured to compress against the surface it is to seal. Further, it should be appreciated that the seal member of the seal 700 may be any suitable material and/or configuration including, but not limited to, a rubber, a plastic, a polymer, a gel, a knife edge and gel, and the like.

In addition, or as an alternative embodiment, there may be one or more intermediate catches, or position indicators, not shown. The intermediate catches may be configured to notify an operator that the container 100 has reached a specific location between the expanded and the collapsed position. The intermediate catches may indicate the position of the lock, as will be discussed in more detail below. Thus, if the operator wants to lock the container in a position between the fully expanded position and the collapsed position, the intermediate catches may indicate the container 100 has reached the intermediate position. The intermediate catches may be located on the guide portions 304 of the container 100. The intermediate catches may be any item configured to signal that the intermediate position has been reached. In one embodiment, the intermediate catches may be a boss on one surface and a detent on the opposing surface. Thus, when the boss engages the detent on the opposing surface, the container will temporarily catch on the detent thereby indicating the intermediate position has been reached. Further, it should be appreciated that the intermediate catches, or position indicators may be any suitable device for indicating a position of the container 100 between the collapsed and expanded position including, but not limited to, an electronic sensor and the like.

The container 100 may include one or more lock portions 110 configured to secure the container 100 into a fixed position, for example the collapsed and expanded position. FIG. 8 shows the one or more lock portions 110 locking the container 100 in the expanded position. The one or more lock portions 110 may include one or more lock actuators 800, one or more locks 802 and one or more lock receivers 804. The lock actuator 800 may be configured move the one or more locks 802 into and out of the one or more lock receivers 804 thereby locking and unlocking the container 100. As shown, the actuator 800 and the one or more locks 802 are located on the top container portion 102 and the one or more lock receivers 804 are located on bottom container portion 104. However, it should be appreciated that the actuator 800 and the locks 802 may be located on the bottom container portion 104 and the one or more lock receivers 804 may be located on the top container portion 102.

The locks 802 and/or lock actuators 800 may be located at several locations on the container 100 in order to increase the strength of the connection between the bottom container portion 104 and the top container portion 102. For example, there may be several locks 802 located in a lower lock portion 806 of the top container portion 102. The locks 802 in the lower lock portion 806 of the top container portion 102 may be configured to engage the lock receivers 804 in an upper lock receiver portion 808 of the bottom container portion 104 when the container 100 is in the expanded position as shown in FIG. 8. Further, the locks 802 in the lower lock portion 806 of the top container portion 102 may be configured to engage lock receivers 804 in a lower lock receiver portion 810 of the bottom container portion 104 when the container is in the collapsed position. Further still, an upper lock portion 812 of the top container portion 102 may be configured to engage the upper lock receiver portion 808 of the bottom container portion 104 when the container 100 is in the collapsed position. There may be any number of lock portions 110 on each side of the container 100. Each side of the container 100 may be a mirror image of the other side of the container 100.

The actuator 800 may be configured to actuate several locks 802 on one or both sides of the container 100. For example, there may be one actuator 800 in each of the lock portions 110 of the container 100, as shown in FIG. 8. In this example, each of the actuators 800 may be operated independently of one another. Further, there may be one actuator 800 which operates all the locks 802 on one side of the container 100, for example an actuator 800 in the lower lock portion 806 of the top container portion 102 may operate all of the lock 802 in the lower lock portion 806 and the upper lock portion 812. Further, still there may be one actuator 800 which operates all of the locks 802 at one elevation on the container 100. For example, one actuator 800 may operate the lower lock portion 806 on each side of the door 106. Further still, there may be one actuator which operates all of the locks 802 on the container 100.

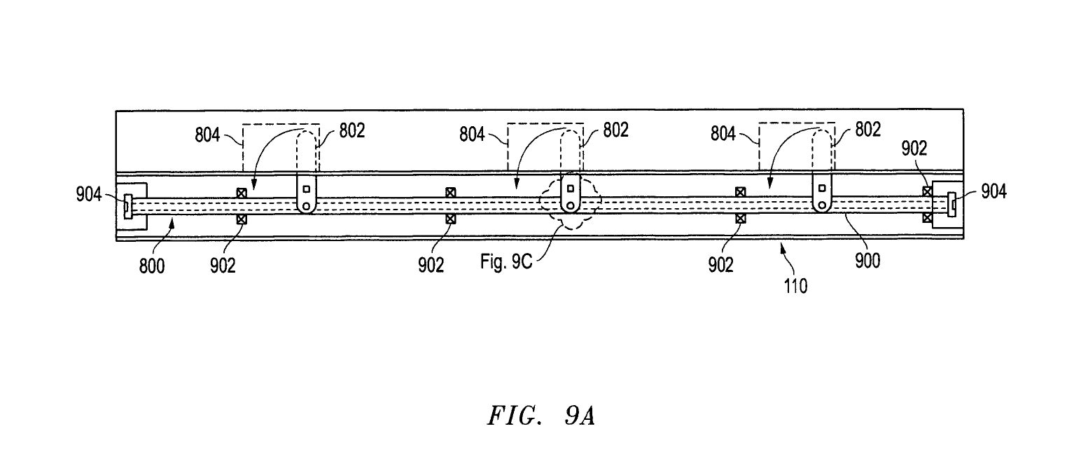

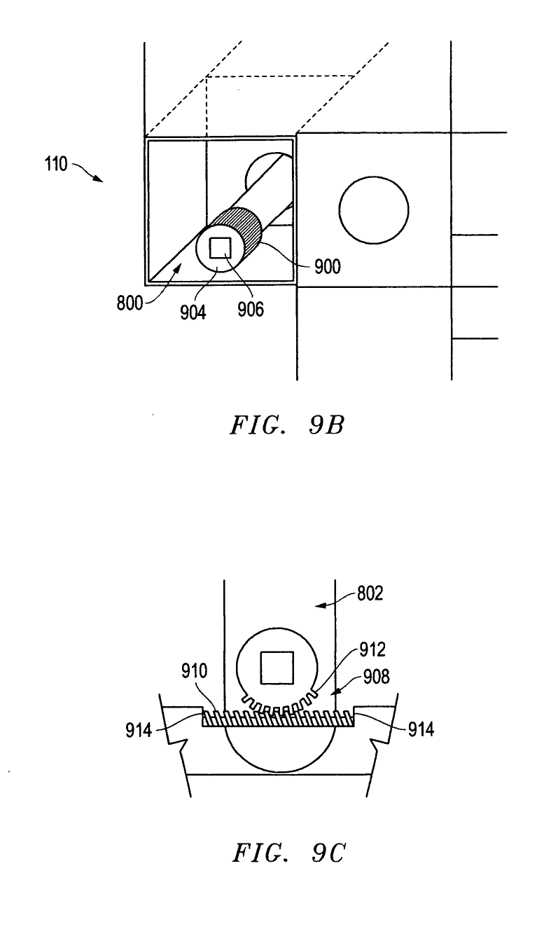

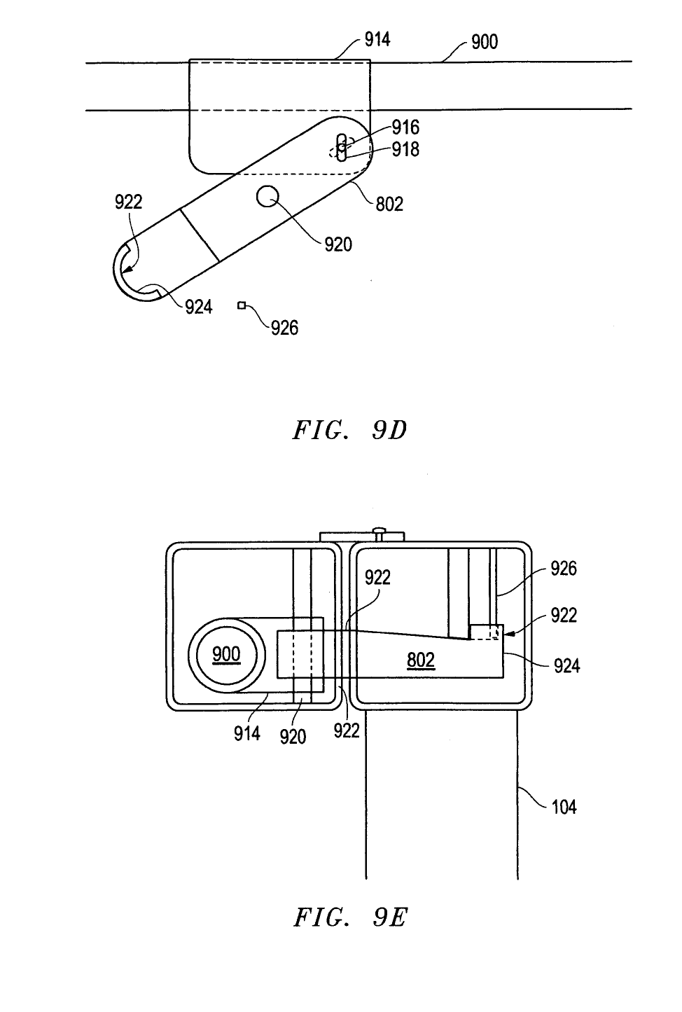

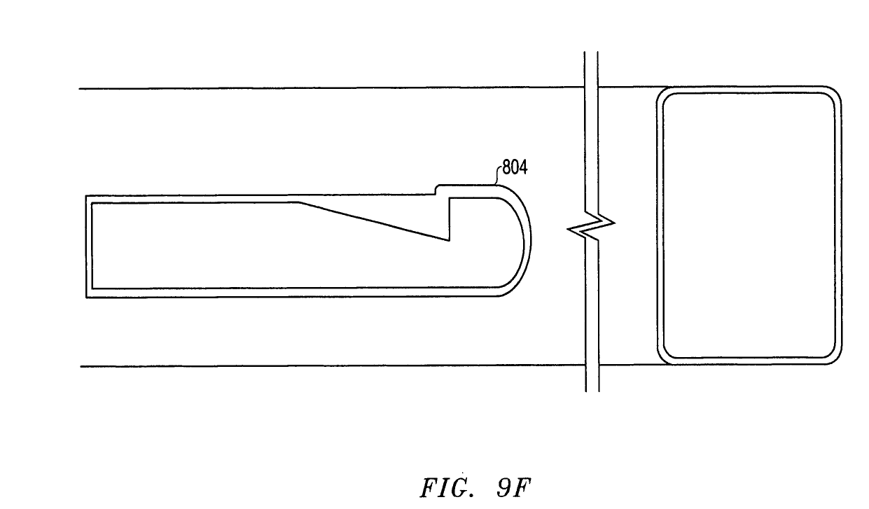

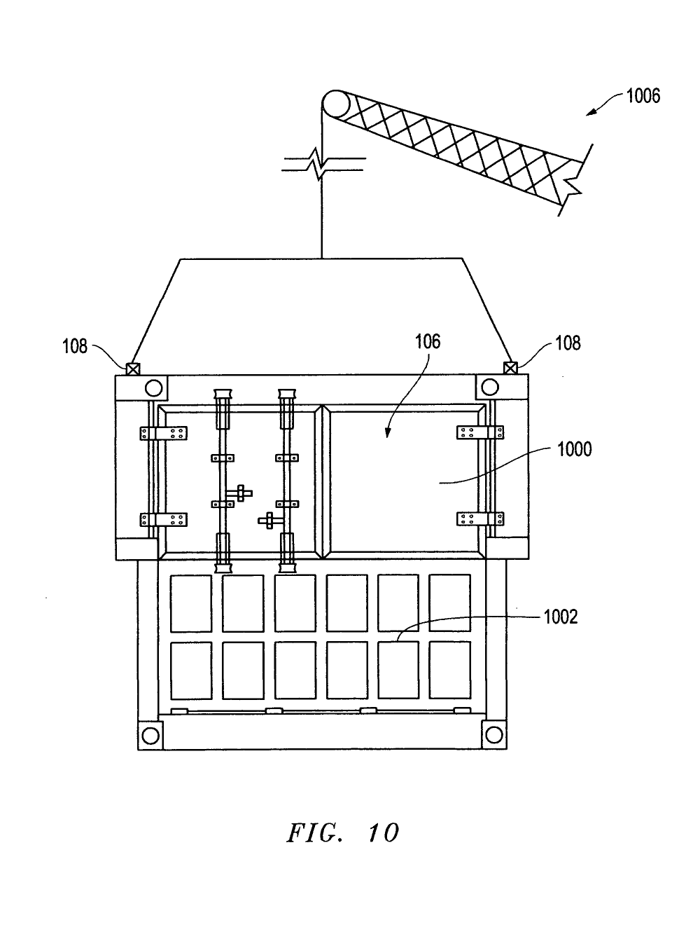

The actuator 800 may be a rod 900 located within the lock portion 110 according to some embodiments. FIG. 9A shows a top view of one of the lock portions 110 according to some embodiments described herein. The rod 900 may extend through the lock portion 110 in order to engage each of the locks 802 in the lock portion 110. The actuator 800, or rod 900, may be accessible from each side of the container 100, as shown in FIG. 9, or only be accessible from one side. There may be one or more rod supports 902, shown schematically, within the lock portion 110 configured to prevent the rod 900 from sagging, or moving radially within the lock portion 110. The rod supports 902 may be any device configured to support the rod 900 radially while allowing the rod 900 to move to actuate the locks 802. To unlock, or lock, the locks 802 the operator may actuate one or more of the actuator ends 904. The actuator end 904 may manipulate the locks 802 as will be described in more detail below. Although the actuator 800 is described as being a rod 900 it should be appreciated that the actuator 800 and/or rod 900 may be any suitable item for manipulating the locks 802 including, but not limited to, a bar, a tube, a pipe, a plate and the like.

The actuator 800, as shown, is configured to actuate the locks 802 by spinning the actuator 800, and/or rod 900. FIG. 9B shows the actuation end 904 of the actuator 800 according to some embodiments. As shown, the actuation end 904 includes a box drive 906 for coupling to a rotation tool, not shown. The rotation tool may have a male drive portion configured to engage the box drive 906. When the rotation tool is engaged in the actuation end 904 an operator may turn on the rotation tool and thereby rotate the actuation end 904 and the rod 900 of the actuator 800. The rotation tool may be any device capable of transferring rotation to the actuator including, but not limited to, an impact gun, a drill, an electric screwdriver, a wrench, a screwdriver, pliers, vice grips, a crescent wrench, a torque wrench, an electric motor, and the like. It should be appreciated that the actuator end 804 may be operated by a motor that is coupled to the actuation end. To this end, the operator may simply push a button in order to lock and unlock the locks 802.

Although, the actuator 800 is described as spinning the rod 900, it should be appreciated that other operations may be used to actuate the locks 802. For example, the actuator may be operated by pushing and pulling the rod 900 within the lock portion 100 thereby moving the locks 802. To this end, the operator may simply push or pull the actuator end 904 in order to lock and unlock the container 100. Further still, there may be a lever coupled to the end of the actuation end 904 configured to assist in the pushing and pulling of the rod 900.

The rod 900 may have one or more threaded portions 908 configured to manipulate the locks 802 as the rod 900 rotates, as shown in FIG. 9C. The threaded portions 908 may only be located near the locks 802, or span substantially the entire length of the rod 900. Each of the threaded portions 908 may include a series of threads 910 configured to engage teeth 912 on a gear 913 according to some embodiments. As the rod 900 spins the threads 910 cause the gear 913 to rotate. The gear 913 may be coupled to the lock 802. Thus, as the rod 900 rotates, the gear 913 causes the lock 802 to rotate. The lock 802 may rotate from a locked position, as shown in FIG. 9A to an unlocked position wherein the lock 802 is substantially parallel with the rod 900. To this end the threaded portions 908 of the rod may have gear stops 914 which prevents the rod 900 from rotating beyond the limit of the lock 802.

In another embodiment, the threaded portions 908 of the rod 900 may be configured to move a collar 915 longitudinally along the axis of the rod 900. The collar 915 may have collar threads, not shown, which engage the threads 910 of the rod 900. When the rod 900 rotates the threads cause the collar 915 to move longitudinally. The longitudinal movement of the collar 915 may cause the lock 802 to engage the lock receiver 804. A portion of the lock 802 may couple to the collar 915. As shown in FIG. 9D a pin 916 coupled to the lock 802 engages a slot 918 on the collar 915. When the collar 915 moves in the longitudinal direction, the slot 918 engages the pin 916 thereby moving the lock 802. The lock 802 pivots about a pivot connection 920 as the pin 916 remains stationary while allowing a portion of the lock 802 to move in a direction perpendicular to the rod 900. The pivot connection 920 may be any suitable connection for causing the lock 802 to rotate around the fixed pivot connection 920. The slot 918 may allow the pin 916 to move in a radial direction relative to the rod 900 as the collar 914 moves in the longitudinal direction. Thus, as the operator actuates the actuator 800, the rod 900 rotates thereby moving the collar 914 in a longitudinal direction relative to the rod 900. The longitudinal movement of the collar 914 causes the lock 802 to move between the locked and unlocked position. Although, the connection between the collar 914 and the lock 802 is described as a pin 916 and slot 918 connection, it should be appreciated that any suitable connection may be used including a bolt and a slot, and the like.

In yet another embodiment, the collar 914 may cause the lock 802 to move laterally without rotation. For example, the lock 802 may be a rigid member coupled to the collar 914. As the collar 914 moves in the longitudinal direction the lock 802 may move in the longitudinal direction with the collar 924 without rotating. In this example, the lock receiving portion 804 may be a slot which is open on one end. Thus, the lock would travel into and out of the slot as the collar 914 moves in the longitudinal direction. It may be necessary to have a slot, or travel path, formed in the exterior of the bottom container portion 104 for the lock 802 to move in as the container 100 moves between the collapsed and expanded position.

The locks 802 must be configured to hold the bottom container 104 and the weight of the contents within the container 100. Thus, the locks 802 may be sized in order prevent the locks 802 from shearing, bending, or yielding during operation. Further, the pivot connection 920 may be large enough to prevent the locks 802 from bending relative to the pivot connection 920 when the locks 802 are carrying a load. Further, the lock portion 110 of the top container portion 102 may have a bearing wall 922 on each side of the lock 802 in order to support the locks 802 when the locks 802 are in the locked position. Thus, with the locks 802 in the locked position on each side of the container 100, the locks 802 prevent the top container portion 102 from moving relative to the bottom container portion 104.

The lock 802 is configured to pass through the lock receiver 804 of the opposing container portion, for example the bottom container portion 104. The lock receiver 804 may have a width and length that is slightly larger than the width and length of the lock 802. Thus, as the locks 802 move into the lock receiver 804 the width and length of the lock receiver 804 allows the locks 802 to enter the bottom container portion 104 easily. The depth of the lock receiver 804 may be sufficient to encompass the locks 802 when the locks 802 are in the locked position. In some embodiments, the length and width of the lock receiver 804 may be substantially constant for the entire depth of the lock receiver 804. Further still, the length and width of the lock receiver 804 may vary in the interior of the lock receiver 804, for example the lock receiver 804 may has a width configured to narrow, thereby engaging the lock 802 as the lock 802 travels into the lock receiver 804. Further still, the length and width of the lock receiver 804 may only have a narrow point at the wall of the container portion, thus, beyond the wall the receiver portion 804 would be an open space.

The locks 802 may be configured to pull the bottom container portion 104 and the top container portion 102 together when in the locked position. To this end the locks 802 may have a latch 922 comprising a cam 924 and base 926, shown in FIG. 9D and 9E. The cam 924 may be configured to engage the base 926 of the receiver portion 804. As shown in FIG. 9D, the cam 924 may be a semicircular lip. The cam 924 may be configured to allow the base 926 into the cammed portion of the latch 922 as the lock 802 is moving toward the locked position. As the lock 802 continues to move toward the locked position the cam 924 begins to pull the base 926 and thereby the container portion, for example the bottom container portion, toward the opposing container portion, for example the top container portion 102. Continued movement of the lock 802 toward the locked position may fully engage the container portions 102 and 104 together. The latch 922 may act as a stop for the movement of the lock 802 toward the locked position. The latch 922 may have any design suitable for engaging the lock 802 to the lock receiver 804 and thereby coupling the container portions 102 and 104 to one another.

In another embodiment, the lock portions 110 may act in a similar manner to a bolt lock. In this example, the actuator 800 would actuate one or more bolt locks straight into a bolt lock receiver portion of the opposing container portion.

In yet another embodiment, each of the lock 802 and lock receiver may include a threaded bolt which screws into a corresponding threaded female connection. To this end, the thread portions 908 of the rods 900 may engage one or more gears configured to rotate the bolt, further a separate member may actuate the bolt and/or the threaded female connection toward the one another.

The door 106, as shown in FIG. 10, includes the top door portion 1000 and the bottom door portion 1002. The top and bottom door portions 1000 and 1002 work to selectively allow access to the interior of the container 100. As shown, the top door portion 1000 consists of two doors. Each of the two doors is hinged to one of the top side walls of the top container portion 102 respectively. Thus, the top door portion 1000 may open and close in a similar manner to French doors. The bottom door portion 1002, as shown, comprises one door which is hinged to the bottom of the bottom container portion 104. The bottom door portion 1002 may be configured to be located slightly within the top door portion 1000 in order to allow the top container portion 102 to collapse, or telescope, over the bottom container portion 104 without impacting the bottom door portion 1002. To this end, the door portions 1000 and 1002 may have a seal, not shown, between the door portions 1000 and 1002 when the door is in the closed position to prevent moisture and/or fluid from entering the door 106. Thus, the bottom door portion 1002 covers a bottom portion of the opening in the closed position and rest on the ground, like a ramp, in the open position. The door 106, as shown, allows a worker to open the two top doors and move them out of the way of the opening while laying the bottom door portion 1002 down to form a ramp to assist in loading and unloading. It should be appreciated that the door 106 may take any suitable form for allowing and prohibiting access to the interior of the container 100 including but not limited to a French door arrangement on both the top door portion 1000 and the bottom door portion 1002.

In an alternative embodiment, the door 106 may be a roll up door, not shown. The roll up door may be configured to roll up onto a roll, or into the roof of the top container portion 102. Further, the roll up door may be configured to roll into the bottom of the bottom container portion 104. The roll up door may have one or more track portions configured to guide the door as it travels between the open and closed position. Because the roll up door would retract, the size of the roll up door could easily adjust to the size of the opening of the container 100. Thus, if the container 100 is in the collapsed position, the door may only need to be extended half way in order to close access to the interior of the container 100.

In yet another alternative, the door 106 may consist of two sets of French door style door as shown in FIG. 1. This door arrangement would allow access to the interior of the container 100 without interfering with the floor area directly in front of the container 100. In this door arrangement, the top door portion 112 may be slightly outside of the bottom door portion 114 in order to allow the container 100 to collapse, or telescope, without interfering with the doors. The doors may include a seal between the door portions 112 and 114 in order to prevent moisture from entering the interior of the container 100.

FIG. 10 depicts a front view of the container 100 according to some embodiments of the inventions. The door 106 of the container 100 is shown having a lock 1004 for securing the door 106 in the closed position. The lock 1004, as shown, is a series of bars which span the top door portion 1000 and secure the bottom door portion 1004. A security lock (not shown), such as a key lock or combination lock, may be secured to the lock 1004 in order to secure the door 106 in the closed position. Although shown as an external lock, it should be appreciated that the lock 1004 may be any suitable lock capable of securing the door 106 in the closed position including, but not limited to, an internal lock, an electronic lock, a lock requiring a remote operator to disengage the lock, and the like. Further, there may be one or more separate locks, not shown on each of the top door portion 112/1000 and the bottom door portion 114/1002.

In order to collapse and expand the container 100 a container expansion system 1006 may be used. The container expansion system 1006 may comprise a crane 1008 used to raise and lower the top container portion in some embodiment. The crane 1008 may couple to each of the lifting lugs 108. A spreader bar 1010, shown schematically, may be used with the crane 1008 in order to substantially transfer the lifting load between the lifting lugs 108. With the crane 1008 attached to the lifting lugs 108 the operator may unlock the top container portion 102 from the bottom container portion 104. The operator may then use the crane 1008 to lower the top container portion 102 relative to the bottom container portion 104. When the top container portion 102 is moved to the collapsed position, the operator may then lock the top container portion 102 to the bottom container portion 104 as described above.

In an alternative embodiment, the container expansion system 1006 may comprise a fork lift. The fork lift may be used to move the container 100 between the collapsed and expanded position. To this end, the top container portion 102 of the container 100 may include fork lift eyes 116, as shown in FIG. 1. The fork lift eyes 116 allow the operator to engage the top container portion 102 with a fork lift and then move the container portion between the collapsed and expanded position.

In yet another embodiment, the container expansion system 1006 may comprise one or more container actuators, not shown. The container expansion system 1006 may be configured to move the container 100 between the collapsed and expanded position. The container actuators may be located in each of the posts, or at any other location within the container 100. In one example, the container actuators may be one or more hydraulic actuators. The hydraulic actuators may raise and lower the top container portion 102 using hydraulic rams placed at each corner of the bottom container 100. This system could be activated remotely, for example from the crane or from a ground operator. Once activated the top container portion 102 would rise into its expanded position and could be lowered into its collapsed position when desired. Further, a pneumatic actuator may be used in a similar manner to the hydraulic actuator. Further still, a mechanical actuator, for example a rack and pinion system could be used to expand and collapse the container 100.

Although the container 100 is described as having only a top container portion 102 and a bottom container portion 104 it should be appreciated that the container 100 may have any number of intermediate container portions, not shown, configured to further collapse the container 100. For example, the top container portion 102 may couple directly to the intermediate container portion in a similar manner as described above. The bottom container portion 104 may couple to the intermediate container portion in a similar manner as described above. The top container portion 102, the intermediate container portion and the bottom contain portion 104 may have a similar length and thereby collapse into one another in the collapsed position.

It should be appreciated that any components, systems and devices described above may be used in any of the container 100. Thus, components described above may be mixed and matched.

In operation one or more containers 100 may be delivered to a warehouse, or other location in the collapsed position. With the containers 100 shipped to the warehouse in the collapsed position, double the number of containers 100 may be delivered using half of the transportation typically necessary. For example, if the containers 100 are being delivered by Semi-tractor trailer, at least two containers 100 may be shipped in place of one standard shipping container. Once at the ware house, the operator may want to load the one or more containers. The operator would then engage the actuator 800 with a tool, or manually, in order to unlock the locking system 110. For example, the operator may engage the actuator 800 with an impact wrench; the wrench would engage the actuator end 904 of the actuator 800. The wrench may then be used to rotate the actuator 800, or rod 900, in the desired direction to unlock the locking system 110. As the wrench rotates the rod 900, the lock 802 is removed from the lock receiver 804 in order to unlock the top container portion 102 from the bottom container portion 104. The actuator 800 may unlock all of the locks 802 between the top container portion 102 and the bottom container portion 104, or the operator may have to repeat this step at another location on the container 100, in order to fully unlock the container 100. With the container 100 unlocked, the operator may now move the container 100 to the expanded position.

The operator may use the container expansion system 1006 to expand the container 100. In one embodiment, the operator uses a fork lift as the container expansion system 1006. For example, the operator may put the forks of the forklift into forklift receiver eyes 116 located on the top container portion 102. The operator may then use the fork lift to lift the top container portion 102. The one or more guide portions 304 within the container 100 assist the container in moving between the collapsed and expanded position without binding, or catching. Further, the friction reducing members 404 may assist in the ease with which the top container portion 102 travels relative to the bottom container portion 104. The operator may lift the top container portion 102 until the limit stop 700 is engaged with the shoulder 702. When the limit stop 700 is engaged with the shoulder 702, there may be a loud noise, or the lifting of the bottom container portion 104 which may indicate to the operator that the limit stop has been hit. A seal between the limit stop 700 and the shoulder 702 may prevent moisture from flowing to and from the container 100 when in the expanded position. With the limit stop 700 engaged, the operator may engage the actuator 800 in the opposite direction as described above. The rotation of the actuator causes the locks 802 to engage the lock receivers 804. With the locks engaged, the container 100 is in the expanded position and ready to be filled with cargo.

The operator may then have the container filled with cargo. The container 100 may then be loaded on a transport device(s), for example a truck, a boat, a train, a plane, and the like, and shipped to a final destination. The container 100 may then be unloaded and then collapsed in the opposite manner as described above. With the container 100 in the collapsed position it may be stored and/or shipped while requiring less space than a standard shipping container.

The container 100 may be an ISO Shipping Container available in all sizes (height and length) that can be collapsed to substantially half its normal height for deadhead shipping. All typical lifting and trucking specifications may remain as ISO standard. These containers 100 will bring substantial savings to the Trucking, Shipping, and Railway Industries. A truck may be able to carry two empty containers as opposed to one. A ship traveling overseas will be able to double its capacity of empty containers without changing the ships loading layout, simply put, two empty containers take the space of one container. Railcars designed to carry a single container, will now be able to carry two, without changing the railcars design.

Embodiments may take the form of varying container sizes, tare weights, and internal dimensions. Further, the container may collapse using methods not depicted in the Figures. For example, the container may collapse by folding each of the walls on top of one another, in an accordion fashion and the like. Further, the container may be configured to collapse in the vertical and horizontal direction. The container may have a similar form in the horizontal direction to allow for the horizontal collapsing. Thus, the user of the container could empty the container, and collapse the container to half of its vertical height and then collapse the length to half of the length. The container may require a series of rollers and actuators to achieve the horizontal collapsing of the container.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A cargo container comprising:
a top container portion comprising:
a roof;
two top side walls;
a top back; and
a top door portion;
a bottom container portion comprising:
a bottom;
two bottom side walls;
a bottom back;
a bottom door portion; and
a container expansion system configured to move the cargo container from an expanded position to a collapsed position, wherein the top container portion is configured to move in a telescoping fashion relative to the bottom container portion between the expanded position and the collapsed position.

2. The cargo container of claim 1, wherein the top container portion is configured to allow the bottom container portion to be contained partially within the top container portion in the collapsed position.

3. The cargo container of claim 1, wherein the bottom container portion is configured to allow the top container portion to be contained partially within the bottom container portion in the collapsed position.

4. The cargo container of claim 1, wherein the top door portion further comprises two top doors which are each coupled to one of the two top side walls.

5. The cargo container of claim 4, wherein the bottom door further comprises a fold down door coupled to the bottom and configured to form a ramp when in the open position.

6. The cargo container of claim 4, wherein the bottom door further comprises two doors which are each coupled to one of the two bottom side walls.

7. The cargo container of claim 6, wherein the bottom doors are configured to move from the open to the closed position with the two top doors.

8. The cargo container of claim 1, wherein the cargo expansion system further comprises a hydraulic lift system.

9. The cargo container of claim 1, wherein the cargo expansion system further comprises a fork lift for engaging fork lift eyes in the top container portion.

10. The cargo container of claim 1, further comprising one or more guide portions configured to guide the relative movement of the top container portion and the bottom container portion.

11. The cargo container of claim 10, further comprising one or more friction reduction devices located at least partially between the top container portion and the bottom container portion in at least one of the guide portions, wherein the friction reduction devices comprise one or more roller bearings.

12. The cargo container of claim 1, further comprising a locking system configured to lock the top container portion to the bottom container portion.

13. The cargo container of claim 12, wherein the locking system further comprises:
an actuator configured to engage a plurality of locks on at least one side of the cargo container; and
a plurality of lock receivers wherein each lock receiver is configured to receive one of the locks.

14. A cargo container, comprising:
a top container portion;
a bottom container portion, wherein the top container portion is configured to move relative to the bottom container portion and wherein at least a portion of the bottom container portion is configured to fit within the top container portion;
one or more locking systems configured to lock the top container portion in an expanded position relative to the bottom container portion; and
a door.

15. The cargo container of claim 14, wherein the door further comprises a roll up door.

16. The cargo container of claim 15, wherein the roll up door is configured to move into a roof of the top container portion when the door is in an open position.

17. The cargo container of claim 14, wherein the door further comprises a top door portion and a bottom door portion.

18. The cargo container of claim 17, wherein the top door portion further comprises two top doors which are each coupled to one of the two top side walls.

19. A method for shipping cargo, comprising:
loading a cargo container with cargo;
shipping the cargo container to a destination;
unloading the cargo container;
unlocking a top portion of the cargo container from a bottom portion of the cargo container;
telescoping the bottom container portion into the top container portion thereby collapsing the cargo container;
shipping the collapsed cargo container to a second destination.

20. The method of claim 19, further comprising expanding the cargo container at the second destination and loading the cargo container with cargo.
